(19) United States
(12) Patent Application Publication
(10) Pub. No.: US 2014/0241727 A1
(43) Pub. Date: Aug. 28, 2014

(54) COMMUNICATION BETWEEN TRANSCEIVERS USING IN-BAND SUBCARRIER TONES

(71) Applicants: Hock Gin LIM, Cupertino, CA (US); Thomas Beck Mason, San Jose, CA (US); Michael Shinsky, Menlo Park, CA (US); Victor Steinberg, Sunnyvale, CA (US)

(72) Inventors: Hock Gin LIM, Cupertino, CA (US); Thomas Beck Mason, San Jose, CA (US); Michael Shinsky, Menlo Park, CA (US); Victor Steinberg, Sunnyvale, CA (US)

(21) Appl. No.: 13/779,444

(22) Filed: Feb. 27, 2013

(51) Int. Cl. H04J 14/02

(52) U.S. Cl. CPC H04J 14/0298
USPC 398/76

(57) ABSTRACT

The invention relates to a system and method of communication between optical transceivers in an optical WDM network, wherein a broad-band modulation of optical signals in a primary frequency band is utilized for transmitting primary high-speed data, while a plurality of relatively low-frequency in-band subcarriers is used to modulate the optical signals to transmit secondary data between network nodes, wherein the plurality of low-frequency subcarriers lie at least in part within the primary frequency band.

### TECHNICAL FIELD

The present invention generally relates to optical communications, and more specifically relates to communication of service information between optical transceivers using low-frequency in-band subcarrier tones.

### BACKGROUND OF THE INVENTION

High speed data communications over optical networks is accomplished using optical transceivers, which convert broad-band electrical data signals generated by users of the network into optical signals modulated at high data rates, and vice versa. An optical transceiver is an electro-optic device that includes both an optical receiver, which receives optical signals from an optical network and converts them into electrical signals for reception by a host device, and an optical transmitter, which converts electrical signals from the host device into optical signals for transmission over the optical network. The optical transmitter and receiver in an optical transceiver may share common circuitry and a single housing, with the optical receiver typically including a receiver optical sub-assembly (ROSA), and the optical transmitter typically including a transmitter optical sub-assembly (TOSA).

One example of optical transceivers are XFP transceivers, which are small form factor “hot-pluggable” protocol-independent transceivers for data communications at 10 Gb/s. XFP transceivers comply with the XFP multi source agreement developed by several leading companies in this industry. The XFP transceiver is used in 10 Gbps SONET/SDH, Fibre Channel, 10G Ethernet and related applications, including the DWDM fiber optic networks. One subclass of XFP transceivers are tunable XFP (T-XFP) transceivers which include tunable lasers which wavelength may be tuned to any one of a plurality of optical channels.

Besides transmitting user-generated data, optical transceivers are also typically required to transmit network management data or other service-type data that are not directly related to the users of the network, but are used to ensure successful network operation and maintenance, including the transmission of data related to the health and operation parameters of the transceiver itself. However, optical transceivers that are currently deployed are ‘data-transparent’ modules that rely on capabilities of a host device and/or a dedicated network management system to either generate the service data or to analyze received data and act upon it. Thus, prior art optical transceivers require a host device and/or a separate network management system to enable transceiver-to-transceiver communications.

One prior-art approach to transmitting network management information is the use of an optical supervisory channel (OSC), which is a separate optical channel that is dedicated to transmitting network management information. However, this method cannot be used when the OSC is unavailable. In another prior art approach, the network management data is multiplexed with regular data by the host device and passed to the transceiver for transmitting over a regular optical channel. One disadvantage of the method is the need to perform the full high speed time division demultiplexing of the entire payload data stream to extract the management data. U.S. Pat. No. 7,792,425 to Aronson, which is incorporated herein by reference, discloses an approach wherein diagnostic and/or configuration data are transmitted using out-of-band (OOB) low-frequency modulation of the optical power generated by the transceiver. One disadvantage of the approach of Aronson is a relatively low total bandwidth that is available for the OOB modulation. Another disadvantage is a difficulty in separating OOB modulation on different WDM channels without optical demultiplexing

An object of the present invention is to overcome the shortcomings of the prior art by providing optical transceivers that are capable of inter-transceiver communications over a regular data-carrying optical channel using low-frequency in-band modulation.

### SUMMARY OF THE INVENTION

Accordingly, the present invention relates to a method of communication in an optical communication system such as an optical network, which comprising: utilizing a broad-band modulation of optical signals in a primary frequency band for transmitting primary data, and utilizing a plurality of low-frequency in-band subcarriers to modulate the optical signals to transmit secondary data between nodes, wherein the plurality of low-frequency subcarriers lie at least in part within the primary frequency band.

An aspect of the present invention relates to an optical receiver for an optical communication system, comprising: a photodetector (PD) for converting an incoming optical signal into an electrical PD signal; a primary signal extraction circuit coupled to the PD for extracting a broad-band electrical data signal from the electrical PD signal; and, a subcarrier receiver subsystem. The subcarrier receiver subsystem comprises a secondary in-band signal extraction circuit coupled to the PD for extracting from the electrical PD signal a low-frequency in-band electrical signal, and a received subcarrier processor coupled to the in-band signal extraction circuit for extracting one or more modulated subcarriers from the low-frequency in-band electrical signal, and for extracting received service data therefrom.

Another feature of the present invention provides an optical transmitter for an optical communication system, comprising: a light emitting module; a broad-band electrical driver electrically coupled to the light emitting module for modulating an output light thereof with a broad-band electrical data signal carrying high-speed data; a subcarrier modulation subsystem for modulating the output light with a low-frequency in-band modulated subcarrier signal carrying out-bound service data. The subcarrier modulation subsystem comprises a modulated subcarrier generator (MSG) for generating one or more in-band subcarriers modulated with the out-bound service data, and a digital to analog converter (DAC) for converting the one or more in-band subcarriers into the low-frequency in-band subcarrier signal for modulating the output light of the light emitting diode therewith. Subcarrier frequencies of the one or more subcarriers are selected from a plurality of designated subcarrier frequencies that lie within a modulation frequency band of the primary broad-band electrical modulation signal.

### BRIEF DESCRIPTION OF THE DRAWINGS

The invention will be described in greater detail with reference to the accompanying drawings which represent preferred embodiments thereof, in which like elements are indicated with like reference numerals, and wherein:

FIG. 1 is a schematic diagram illustrating an optical communication link utilizing in-band subcarriers;

FIG. 2 is a general block diagram of an optical transceiver utilizing in-band subcarriers;

FIG. 3 is a schematic diagram illustrating the main frequency band for the data transmission between transceivers at a line data rate, and a plurality of modulated subcarriers for transmitting service data;

FIG. 4 is a schematic block diagram of a transmit path of the optical transceiver of FIG. 1 with subcarrier modulation by current addition to laser SOA section;

FIG. 5 is a schematic block diagram of a transmit path of the optical transceiver of FIG. 1 with subcarrier modulation by current addition to a drive current of a directly modulated laser;

FIG. 6 is a schematic block diagram of a transmit path of the optical transceiver of FIG. 1 with subcarrier modulation by controlling a fast VOA in the optical path of the optical transmitter;

FIG. 7 is a schematic block diagram of a receive path of the optical transceiver of FIG. 1 with received subcarrier extraction and de-modulation;

FIG. 8 is a circuit diagram illustrating an electrical circuit for a PD bias provisioning and signal extraction of the in-band sub-carrier signals;

FIG. 9 is a circuit diagram illustrating a first portion of an electrical circuit for subcarrier signal extraction;

FIG. 10 is a circuit diagram illustrating a second portion of the electrical circuit for subcarrier signal extraction;

FIG. 11 is a schematic block diagram illustrating a subcarrier signal and data extraction sub-system of the receive path of the optical transceiver of FIG. 8;

FIG. 12 is a block diagram of a subcarrier FPGA implementing digital generation and reception of modulated subcarriers in accordance with one embodiment of the invention.

### DETAILED DESCRIPTION

The following definitions are applicable to embodiments of the invention: the terms ‘high-speed signal’, ‘high-frequency signal’, ‘high data rate signal’, ‘broad-band signal’ and ‘broad-band data’ refer to data, typically user-originated, and/or corresponding signals that are transmitted over an optical communication link by modulating an optical carrier at a line rate of the link, typically above 100 Mb/s. The terms ‘low-speed’, ‘low-frequency’, ‘low [data] rate’ refer to service data and/or corresponding signals that are transmitted by modulating an optical carrier at a rate that is at least an order of magnitude lower than the line rate, and typically below 50 Mb/s. The term ‘service data’ refers to data that is generated and transmitted for the benefit of the optical communication system itself rather than its users, such as data related to system and/or transceiver configuration, diagnostic and maintenance. The term ‘transceiver’ as used herein refers to a device that incorporates a receiver and a transmitter, and encompasses transducers. The term ‘node’ as used herein refers to a connection point of a transceiver in an optical communication system and encompasses a termination point of an optical communication link.

Note that as used herein, the terms “first”, “second” and so forth are not intended to imply sequential ordering, but rather are intended to distinguish one element from another unless explicitly stated otherwise. Furthermore, the following abbreviations may be used:

ASIC Application Specific Integrated Circuit

FPGA Field Programmable Gate Array

BPSK Binary Phase Shift Keying

QPSK Quadrature Phase Shift Keying

FEC Forward Error Correction

SPI Serial Peripheral Interface (Bus)

ADC Analog to Digital Converter

DAC Digital to Analog Converter

WDM Wavelength Division Multiplexing, encompasses DWDM

DWDM Dense Wavelength Division Multiplexing

SOA Semiconductor Optical Amplifier

PD Photodetector

Embodiments of the invention relate to circuit and system design for transmission and high sensitivity reception of low speed in-band digital data by modulation of optical power with single or multiple sub-carriers. In one exemplary embodiment, the sub-carriers are spaced 5 to 20 KHz apart, for example 10 kHz apart, in the frequency range for example from 100 to 1500 kHz, enabling more than 100 channels; each sub-carrier in this embodiment is capable of carrying data at typically 1.125 kbps but may transfer data at any rate between 100 bps and 5 kbps. It is to be understood however that these values are by way of example only, so that different combinations of subcarrier spacing and subcarrier data transfer rates may also be used in embodiments of the present invention. The absolute frequency accuracy of the sub-carrier frequencies should be sufficient to enable subcarrier separation and decoding at reception, for example within 50 ppm.

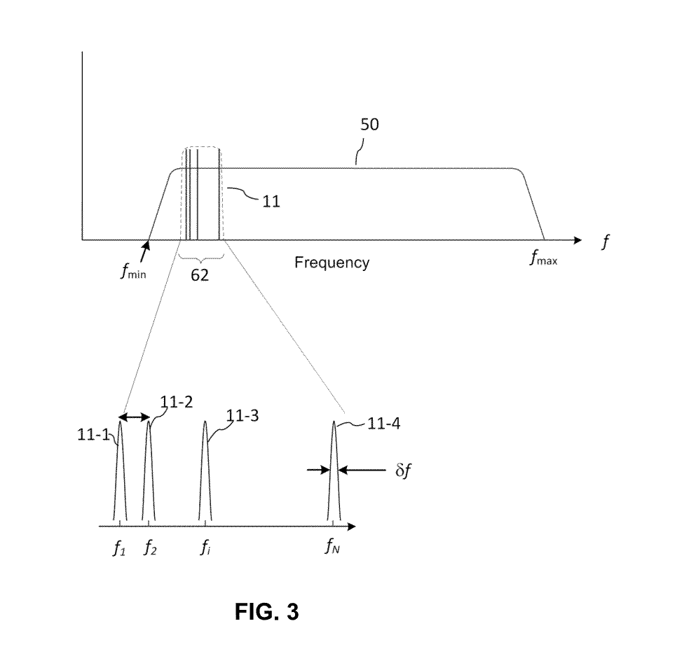

One aspect of the present invention provides a method of communication in an optical communication system, such as for example a WDM network, wherein primary data are transmitted using a broad-band modulation of optical signals, while auxiliary data are transmitted by modulating the optical signals using a plurality of low-frequency subcarriers. In one embodiment, the primary data may include user-generated data, while the auxiliary data my include network- and/or transceiver-related service data. In the context of the present invention the broad-band modulation may also be referred to as the primary modulation, which implements a primary communication channel. In a spectral representation, the broad-band modulation is characterized by a wide modulation frequency band (50 in FIG. 3) that may be referred to herein as a primary frequency band. The lower-frequency subcarrier modulation for transmitting the secondary data may also be referred to herein as the secondary, or auxiliary modulation.

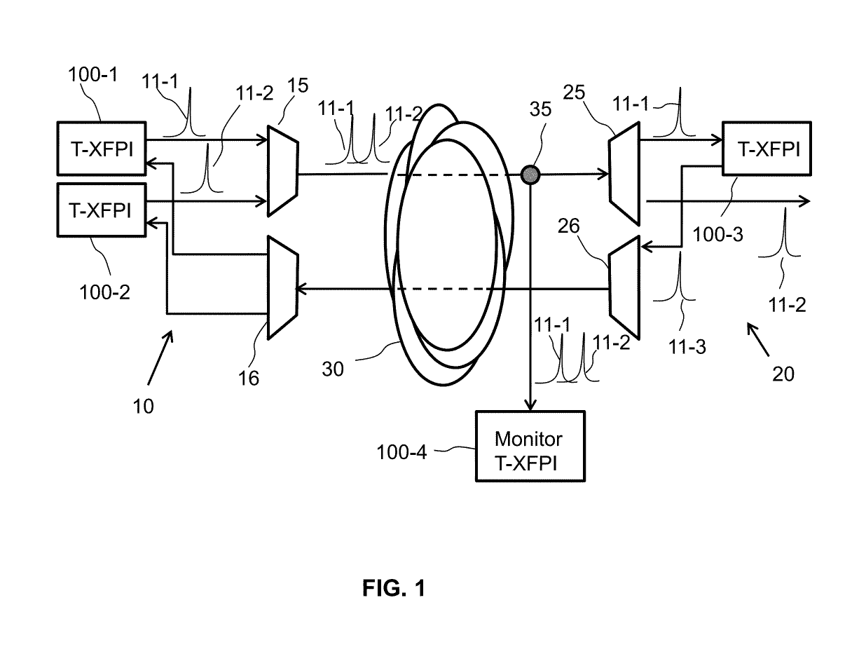

With reference to FIG. 1, there is schematically illustrated an exemplary portion of a fiber-optic WDM network utilizing features of the present invention. The illustrated network portion includes first and second optical nodes 10, 20 that are connected by an optical link 30, which is shown schematically as a cloud and which may include intermediate optical devices and systems such as optical amplifiers, optical routers, dispersion compensation modules, reconfigurable optical add-drop multiplexers (ROADM), and the like. Nodes 10, 20 include optical transceivers 100-1, 100-2, and 100-3, which are generally referred to as transceivers (TR) 100 and which are configured for inter-transceiver communication in accordance with an embodiment of the present invention. Each transceiver 100 has an output optical port coupled to one of input ports of an optical multiplexer 15 or 25, and an input optical port coupled to an output of an optical de-multiplexer 16 or 26. By way of example, transceivers 100 may be tunable XFP (T-XFP) transceivers that are tunable to receive and transmit optical signals at any optical channels from a plurality of optical DWDM (dense wavelength division multiplexing) channels on a 100 GHz ITU grid as known in the art, and which are adapted for in-band inter-transceiver communications using narrow sub-carrier tones. Other embodiments include non-tunable transceivers for operating on specific optical channels, as well as optical transceivers that do not comply with the XFP standard. Further by way of example only, the first TR 100-1 at node 10 and the third TR 100-3 at node 20 may be configured, or tuned, for operation on the DWDM channel 191.200 THz (terahertz), while the second TR 100-2 at node 10 may be configured, or tuned, for operation on the DWDM channel 196.100 THz.

In operation, light emitted by each of these transceivers is broad-band modulated to transmit user data between nodes 10 and 20 at a high line rate, such as 2.4 GB/s, 10 Gb/s, or beyond. Additionally, in accordance with an embodiment of the present invention the optical output of each of these transceivers is further modulated at relatively low frequencies using one or more in-band sub-carriers at the subcarrier frequencies fᵢ; these modulated in-band sub-carriers are schematically represented in FIG. 1 by spectral peaks 11-1, 11-2, 11-3, and will be generally referred to herein as sub-carriers 11.

In one embodiment, the frequencies of the subcarriers 11 are selected by the transceivers 100 from a pre-defined set of subcarrier frequencies fᵢ, i=1, . . . , N. The subcarrier frequencies fᵢ may be uniformly or non-uniformly spaced. In one embodiment the subcarriers are uniformly spaced in frequency by a subcarrier frequency spacing Δf. By way of example, Δf may be about 10 kHz or greater, and the subcarriers occupy a frequency range from about 100 kHz to about 1500 kHz, enabling more than 100 unique sub-carrier channels. In one embodiment, the subcarrier frequency fᵢ for each transceiver 100 may be selected in dependence upon the DWMD channel it is tuned to, and uniquely defines this channel in at least a portion of the network. By way of example, the optical outputs of the first and second transceivers 100-1, 100-2 are modulated at a subcarrier frequency f₁=100 kHz, while the optical output of the second transceiver 100-2 is modulated at a subcarrier frequency f₂=1100 kHz. In another embodiment, each DWDM channel may be associated with more than one subcarrier frequency, and this association may also be made unique in a sense that each subcarrier frequency uniquely defines a DWDM channel in a portion of the network. Advantageously, associating each subcarrier frequency with a particular WDMD channel enables fault detection in the network.

In one embodiment, each subcarrier 11 may be narrow-band modulated using a suitable modulation format, such as BPSK or QPSK encoding, to carry service data between the transceivers 100, thereby enabling inter-transceiver signaling. In the context of this specification, the term ‘service data’ refers to data that relates to the network configuration, maintenance and diagnostics, including data related to the configuration, maintenance and diagnostics of the transceivers themselves. By way of example, service data may include data related to transceiver control information, such as a command to change the optical frequency or transmission power of the tunable transceiver, and transceiver digital diagnostics information, such as data related to device temperature, receiver power, laser temperature, and the like.

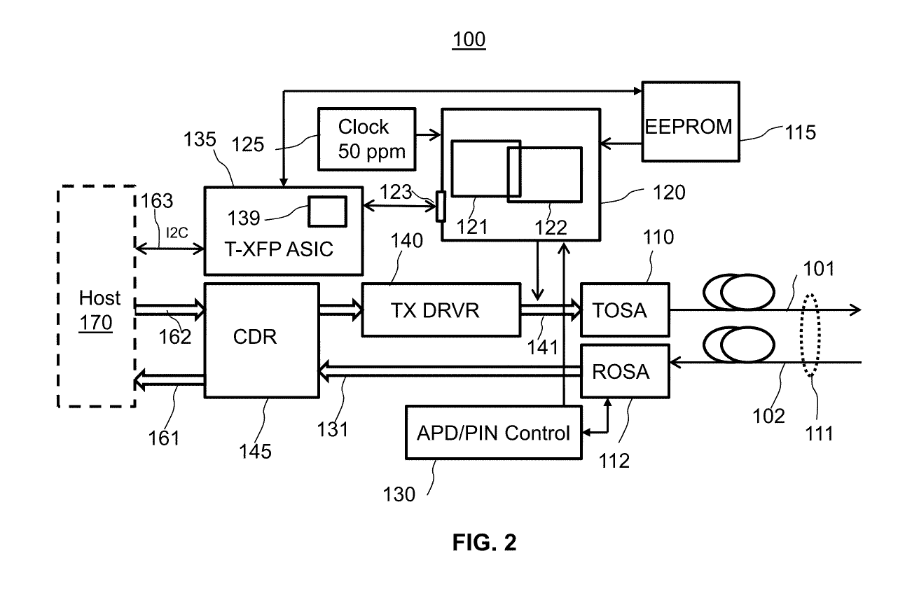

With reference to FIG. 2, there is illustrated a schematic block diagram of the transceiver 100 in accordance with an embodiment of the present invention. In a receive path, the transceiver 100 includes a ROSA 112, which electrically connects to an optional clock-and-data recovery circuit (CDR) 145. ROSA 112 incorporates a broad-band photodetector (PD) and has an input optical port for connecting to a ‘receive’ optical fiber 102 of an optical link 111, and at least two electrical ports—a broad-band port for outputting a received broadband electrical signal 131, and an electrical bias port that connects to a PD control circuit (PDCC) 130. Different designs of the ROSA 112 are known in the art and could be used in various embodiments of the present invention. In one embodiment the broad-band PD in ROSA 112 is either a pin photodiode or an avalanche photodiode (APD), which is mounted on a suitable circuit board with a broad-band electrical connector and is optically coupled to a fiber optic pigtail connecting to the receive fiber 102.

In a transmit path, the transceiver 100 includes an optical signal source, such as a light emitting module in the form of a TOSA 110, having an output optical port that connects to a ‘transmit’ optical fiber 101, and an input electrical port that connects to a transmitter driver circuit 140, which serves as an electrical modulator. Different designs of the TOSA 110 are known in the art and could be used in the present invention. Typically, TOSA 110 includes an optical source, such as a semiconductor laser device, which is mounted on a suitable circuit board with a broad-band electrical connector and is optically coupled to a fiber optic pigtail having a suitable fiber-optic connector at the opposite end thereof for connecting to the transmit fiber 101.

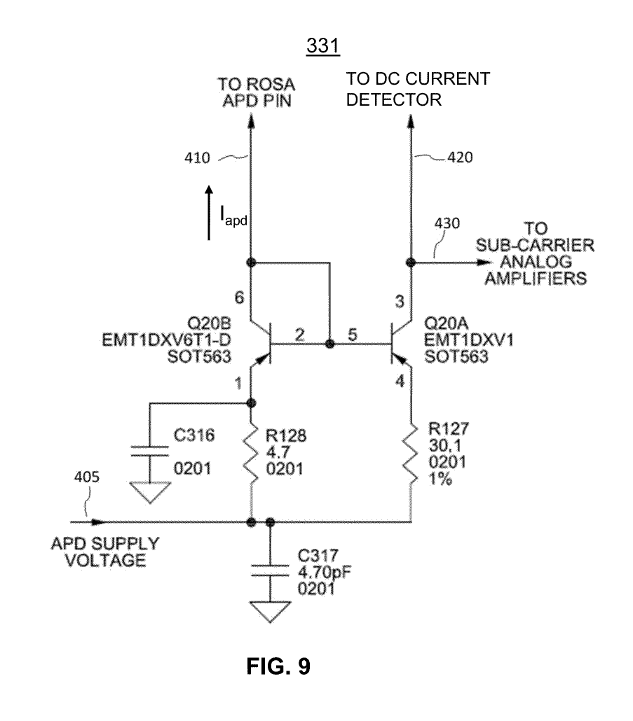

In operation, ROSA 112 converts an incoming optical signal received over the optical fiber link 111 into an electrical PD signal, and extracts therefrom the received broad-band data signal 131, for example using a trans-impedance amplifier (TIA) 430 as illustrated in FIG. 9. In one embodiment, this received broad-band data signal 131 is passed to the optional CDR 145 for clock and data recovery as known in the art. In response, CDR 145 outputs a recovered primary data signal 161 that is passed to a host device 170. In some embodiments, the TR 100 may include a SerDes (serializer/deserializer) for converting the serial CDR output into several parallel data streams of lower data rate as known in the art. In embodiments wherein the TR 100 lacks the CDR 145, the received broad-band data signal 131 may be directly passed to the host device 170. The host device 170, which is external to the TR 100, may perform further processing of the received electrical data signal 161 or 131 as required, such as electrical de-multiplexing into a plurality of data streams for passing to respective users.

In the transmit path, a high-bit-rate data signal 162 generated by the host 170 is passed, in one embodiment through the optional CDR 145, to the Tx driver 140, which converts it into a broad-band electrical modulation signal 141 for modulating the optical source 110. Blocks 145, 140, 110, 112, and 130 having aforedescribed functionalities are well known in the art, are typically present in commercial XFP transceivers, and their implementation will not be described herein in further detail, except when implementing one or more functionalities provided by the present invention.

The transceiver 100 further includes a main TR controller 135 and a subcarrier controller 120. The subcarrier controller 120, which is a feature of the present invention, implements the subcarrier generation and processing functionalities of the transceiver 100, and may also be referred to as a digital subcarrier transceiver 120. The main TR controller 135, which by way of example may be embodied using an ASIC or a microcontroller, implements conventional transceiver control functions for controlling the operation of the TOSA 110 and ROSA 112 and their associated circuitry 140, 130, such as controlling multiple current and voltage sources required to operate a tunable optical transmitter within the TOSA 110 if the transceiver 100 is an T-XFP transceiver. The main TR controller 135 connects to a host device 170 using a data link 163 such as an I2C bus, thereby enabling the host 170 to control the operation of the transceiver 100 and to monitor its characteristics and ‘health’. The functionalities of the main controller 135 that are related to the TOSA and ROSA control in conventional transceivers are well known in the art and will not be described here in further detail. According to an embodiment of the present invention, the main TR controller 135 may additionally include a programmable portion 139 that implements one or more sub-carrier communications applications and management of various functions of the sub-carrier controller 120. By way of example, the main controller 135 may be programmed to read and execute a subcarrier-delivered command to change one or more of the operating conditions of the transceiver 100, similar to features available when controlled by a local host device 170. For a tunable transmitter this may include changing the laser frequency of the carrier signal. Other subcarrier communication applications implemented in the main TR controller 135 includes applications for transmitting digital diagnostics and alarm status to a remote transceiver; which may include looped back digital diagnostics and alarm status.

According to an aspect of the present invention, the transceiver 100 includes electrical circuitry or sub-system for in-band subcarrier modulation of the optical output of the optical source 110, and for extracting and de-modulating in-band subcarriers from the optical signal received by the ROSA 112. In the shown embodiment, this additional circuitry includes the subcarrier controller (SC) 120, with a source of a clock signal 125 and an optional memory unit 115, such as an EEPROM, coupled thereto. The clock source 125 and the memory unit 115 may also be comprised in the SC 120. In one embodiment, memory 115 stores subcarrier frequency tables listing allowable subcarrier frequencies fᵢ. It may also store subcarrier control application code controlling subcarrier generation and processing functionalities of the subcarrier controller 120. In one embodiment, the SC 120 includes a modulated subcarrier generator (MSG) 121 for generating modulated subcarrier signals for transmitting using the TOSA 110, and a received subcarrier processor (RSP) 122 for processing received subcarrier signals. Blocks 121 and 122 may also be referred to herein as the digital subcarrier transmitter 121 and the digital subcarrier receiver 122, respectively. The SC 120 may be embodied using one or more digital processors, such as an DSP, FPGA, an ASIC, a microcontroller, and the like, and may further include one or more analog amplifiers for amplifying received subcarriers, a digital to analog converter (DAC), and an analog to digital converter (ADC). MSG 121 and RSP 122 may optionally share one or more common elements, which is illustrated in the figure by the overlapping of respective blocks. The SC 120 has a digital interface 123 for communicating with the TR controller 135, which may be embodied for example using I²C and/or SPI communication bus as known in the art, for the purpose of exchanging in-band service data and controlling parameters of the subcarrier communications.

Using this additional circuitry, the transceiver 100 may engage in a point-to point communication with a remote transceiver at the opposite end of the communication link 111; by way of example, transceiver 100 of FIG. 2 may represent transceiver 100-1 of FIG. 1, with the remote transceiver being transceiver 100-3, or vice versa. In particular, transceiver 100 may transmit service data, which may be generated by the transceiver 100 itself or received from a host device 170, to the remote transceiver, and may also receive service data from the remote transceiver. When referring to a particular transceiver 100, service data generated by the transceiver 100 or obtained by its host device 170 for transmitting to the remote transceiver may be referred to herein as the out-bound data, while service data that are received from the remote transceiver by the transceiver 100 may be referred to as the in-bound data.

By way of example, the main controller 135 may generate service data that includes remote transceiver control information, such as output optical power and optical channel settings for the remote transceiver, and digital diagnostic information for the remote transceiver such as temperature, bias current etc. Further by way of example, the TR controller 135 may obtain service data from the host 170 using the data communication link 163, such as the I2C bus. Service data that the main controller 135 may receive from host 170 includes conventional digital diagnostics information as well as “remote” digital diagnostics information. Service data from host 170 may also include a host to remote host data. In one embodiment the main controller 135 may support a suitable message protocol for transmission of data that can be uniquely decoded into various applications at the remote transceiver or its host. Such protocol may generally include packetizing data and commands for the remote transceiver, providing packet headers, and optionally an error checking mechanism as known in the art, and may be defined by a system integrator in accordance with specific requirements of a particular system.

Referring to FIG. 3, the term ‘in-band’ is used in the present specification to refer to modulation frequencies within the frequency band 50 in which the optical output of the TOSA 110 is being modulated by the high-bandwidth electrical modulation signal 141 carrying the high-bit-rate user data 162. In a typical transceiver, this frequency band extends from a non-zero minimum frequency fₘᵢₙ to some maximum frequency fₘₐₓ that depends on the line rate of the transceiver; both fₘₘ and fₘₐₓ are controlled by electrical circuitry in the transmitter path. By way of example, fₘᵢₙ may be on the order of 100 kHz, and fₘₐₓ may be in the GHz region, for example on the order of 12 GHz for a 10 Gb/s line rate transceiver. According to an aspect of the present invention, the optical output of the transceiver 100 may be additionally modulated at low frequencies with one or more subcarriers 11 centered at subcarrier frequencies fᵢ, i=1, . . . , N, within a subcarrier frequency band 62, so as to transmit service data to the remote transmitter. According to one aspect of the present invention, the subcarriers 11 lie within the main modulation band 50 of the transceiver 100, and therefore are referred to herein as the in-band subcarriers. The service data that are carried by these subcarriers may also be referred to herein as the in-band data, in contrast to out-of-band data and out-of-band modulation disclosed for example in U.S. Pat. No. 7,792,425, which is incorporated herein by reference. Advantageously, using in-band modulation allows for a larger overall bandwidth than that is available for the out-of-band modulation. In addition, using sub-carrier modulation provides an ability to support a plurality of in-band data channels that could be individually accessed with or without optical de-multiplexing, simply by using different sub-carriers to transmit different data, and by using narrow-band electrical or digital filters at reception to access individual subcarriers. In one exemplary embodiment of the invention, each subcarrier frequency is associated with a specific DWDM channel and effectively transmits 1.125 kbps of data per sub-carrier. In one embodiment, a sub-set of the supported sub-carrier frequencies may be reserved for a specific purpose or purposes. In one embodiment SC 120 is able to extract modulated data from only a single subcarrier channel at a time. In other embodiments the SC 120 can demodulate multiple subcarriers simultaneously.

In one embodiment, service data to be transmitted are packetized into frames, each frame consisting of a certain number of bits; by way of example, each frame may be comprised of 90 bits. In one embodiment, data within the frames can be encrypted, scrambled, parity checked and error corrected using standard prior art protocols and coding techniques, such as for example 8B10B line encoding, for framing and error correction. By way of example, one frame may include fields defining a message type, such as ‘command’ or ‘data’, message command codes, followed by respective message data.

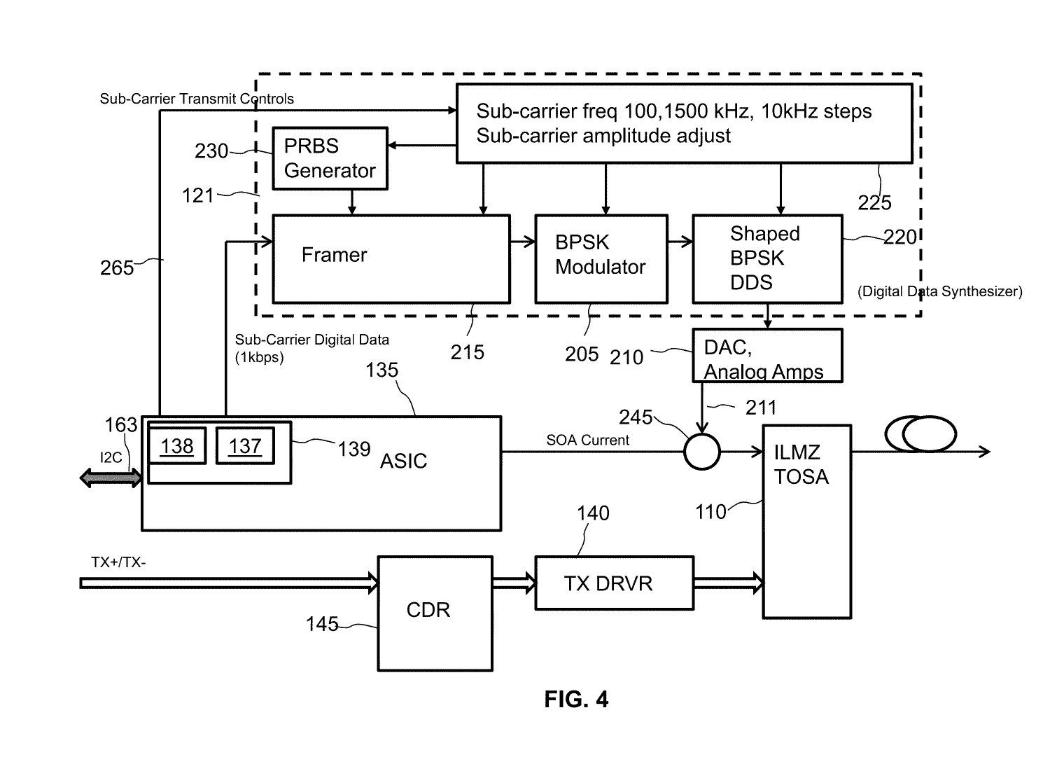

With reference to FIG. 4, there is illustrated a block diagram of a transmitter portion of the transceiver 100 in one embodiment thereof; this block diagram may also represent a separate optical transmitter device according to one aspect of the present invention. The subcarrier modulation subsystem of the TR 100, which in operation modulates the output light with a low-frequency in-band modulated subcarrier signal carrying out-bound service data, includes the MSG circuit 121 and a DAC block 210, which may optionally include amplifiers. The MSG 121 in this embodiment includes a tunable subcarrier frequency generator (SFG) 225, a PRBS generator 230, a framer 215, a modulator 205, and a digital data synthesizer (DDS) 220. In the shown embodiment the modulator 205 is a BPSK modulator, although modulators using other suitable modulation formats, such as amplitude modulation, frequency modulation, and QPSK, may also be used. In one embodiment the main controller 135 includes a subcarrier frequency control logic 138 for controlling the subcarrier frequency or frequencies to be transmitted, and a service data source 137, which provides out-bound service data to be transmitted to the remote transceiver with the selected subcarriers. In one embodiment the main controller 135 can also accept messages from the host over the data link 163 to be included as part of the outbound service data generated by the data source 137. In operation, the out-bound data that are passed from the service data source 137 to the MSG 121 are packetized into frames by the framer 215, which may also use a suitable forward error correction (FEC) algorithm, and may attach a header to each frame. In one embodiment, the framer may use a suitable data encoding technique, such as 8B10B line encoding, to encode the outbound data. The resulting data frames or packets are then BPSK encoded using a BPSK modulator 205 or other suitable modulator. The encoded service data are then passed to the DDS 220, which also receives a digital tone signal at a selected subcarrier frequency fᵢ from the SFG 225, and are used by the DDS 220 to synthesize a digital modulated subcarrier signal at the selected subcarrier frequency fᵢ, which is BPSK-modulated by the out-bound service data. In one embodiment, the subcarrier frequency fᵢ is selected based on a control signal 265 from subcarrier control logic 138 of the main controller 135. The digital shaped modulated subcarrier signal generated by the DDS 220 is suitable for driving a DAC 210. In one embodiment, SFG 225 generates the subcarrier frequency tone from the external clock 125 (FIG. 2) with accuracy of 50 ppm. In one embodiment, both the frequency fᵢ and amplitude of this signal can be controlled by the subcarrier control logic 138 of the main controller 135. In one embodiment, the data source 137 provides the out-bound service data to the SC 120; the PRBS generator 230 may serve as a data source in a test mode. In one embodiment, the out-bound service data are packetized, framed, optionally scrambled, and FEC encoded by the framer 215 into a data stream which is fed into the BPSK modulator 205 at a suitably low data rate that may generally depend on the subcarrier spacing, for example at 1.125 kbps. The BPSK modulator 205 may optionally shape the modulation signal so as to limit its bandwidth and to reduce cross-talk between modulated subcarriers. DAC 210, which receives the digital subcarrier signal at the selected subcarrier frequency fᵢ that is modulated by the out-bound service data from DDS 220, may be either external to the SC 120, or it may be implemented within the SC 120. In one embodiment, the subcarrier modulator 205 may generate two or more modulation signals, which are then used by the DDS 220 to modulate two or more digital subcarrier tones that are provided to the DDS 220 by the SFG 225. In this embodiment, the output subcarrier signal of the DDS 220 is a sum of two or more digital modulated subcarriers. By combining multiple subcarriers in the transmitted signal 211, higher data rates may be utilized when required.

The DAC circuit 210, which may optionally include an analog amplifier, converts the modulated subcarrier signal into an analog subcarrier signal 211, which is then used as a subcarrier modulation signal to modulate the output optical power of the TOSA 110; this may be accomplished, for example, by adding the subcarrier signal 211 to an electrical signal that controls the output optical power of the TOSA 110. In one embodiment the analog subcarrier signal 211 is in the form of a narrow-band AC electrical signal having a generally sinusoidal waveform that is narrow-band modulated in amplitude and/or phase, and having a spectrum that is centered at the selected subcarrier frequency fᵢ, with the bandwidth that is less than the subcarrier frequency spacing, as illustrated in FIG. 3. In some embodiments, the analog subcarrier signal 211 may be a superposition of several such modulated subcarrier tones, for example when the amount of service data to be transmitted is relatively large.

The amplitude of the subcarrier modulation signal 211 is selected so as to provide a desired modulation depth of the output optical power from TOSA 110 at the subcarrier frequency. By way of example, the subcarrier modulation depth may generally be in the range of 1 to 70%, and preferably in the range 3 to 10%.

Depending on the optical source used in the TOSA 110, there may be multiple ways to modulate its optical output with the analog subcarrier signal 211. In embodiments wherein TOSA 110 includes a semiconductor optical amplifier (SOA), the analog subcarrier signal 211 may be added to a bias current of the SOA, for example using a current adder 245. In one embodiment, the current adder 245 may be simply a junction of the respective conducting lines. By way of example, TOSA 110 may include a photonic integrated circuit (PIC) transmitter that is known in the art as the Integrated Laser Mach Zehnder (ILMZ), which incorporates a widely-tunable semiconductor laser, an optical Mach Zehnder modulator, and a SOA section in a same chip. The analog subcarrier signal 211 may be added to the bias current of the SOA section. In another embodiment, for example wherein the TOSA 110 does not include an SOA section or device, the subcarrier signal 211 can be added directly to the laser bias current. This, however, may not always be recommended for a tunable TOSA due to the known dependence of the optical wavelength on the bias current to a laser gain section.

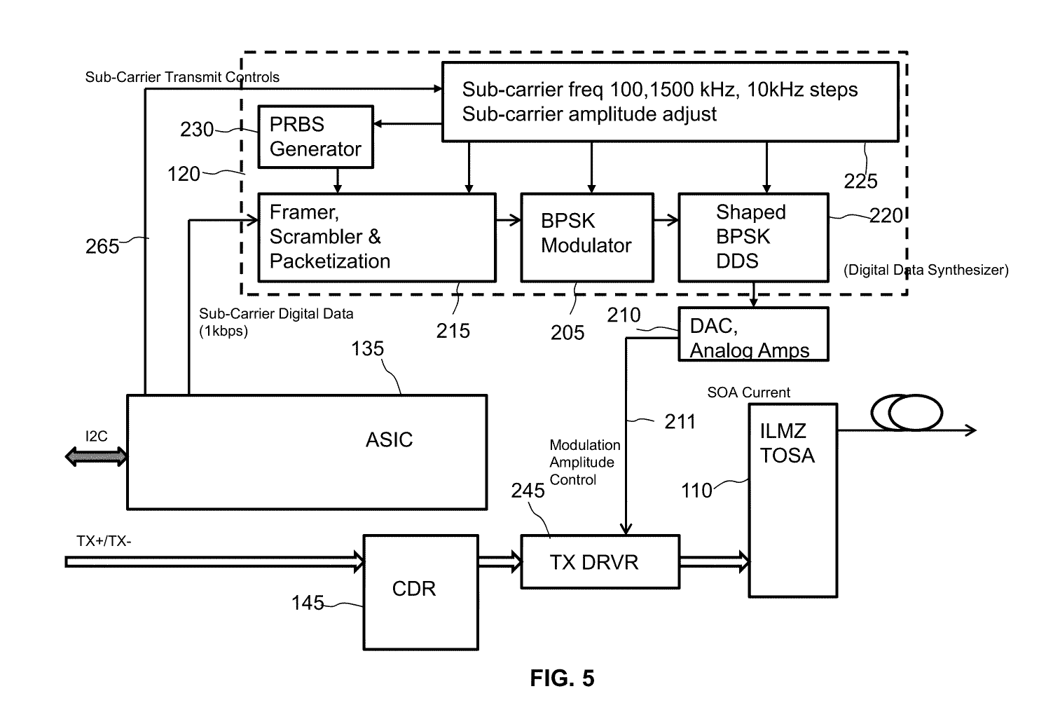

With reference to FIG. 5, in another embodiment the in-band subcarrier modulation of the optical output of the TOSA 110 is achieved by voltage modulation to an input of the TX driver 245. As one skilled in the art will appreciate, the amplitude of the output signal of the TX driver 245 is linearly correlated with an analog DC voltage into the TX driver, which controls an operating point of a broad-band modulation amplifier within the TX driver 245. In this embodiment, the analog subcarrier signal 211 that is generated by DAC circuit 210 is a voltage signal that is composed of a DC offset voltage with the AC sub-carrier signal content. This voltage signal 211 is added to the input control voltage of the TX driver 245.

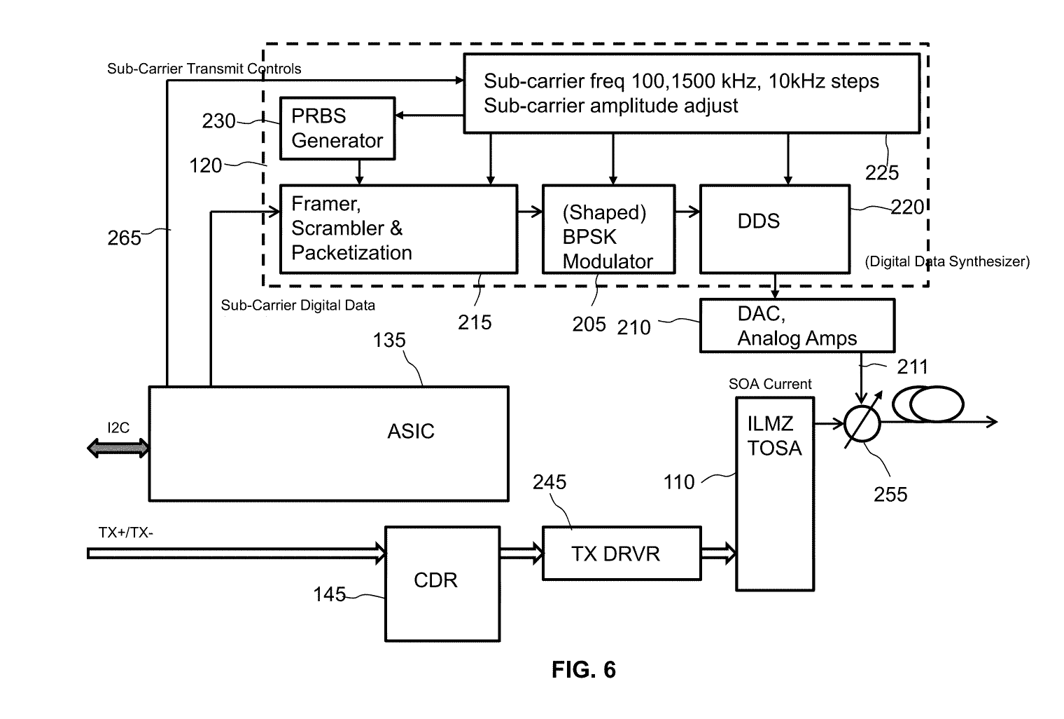

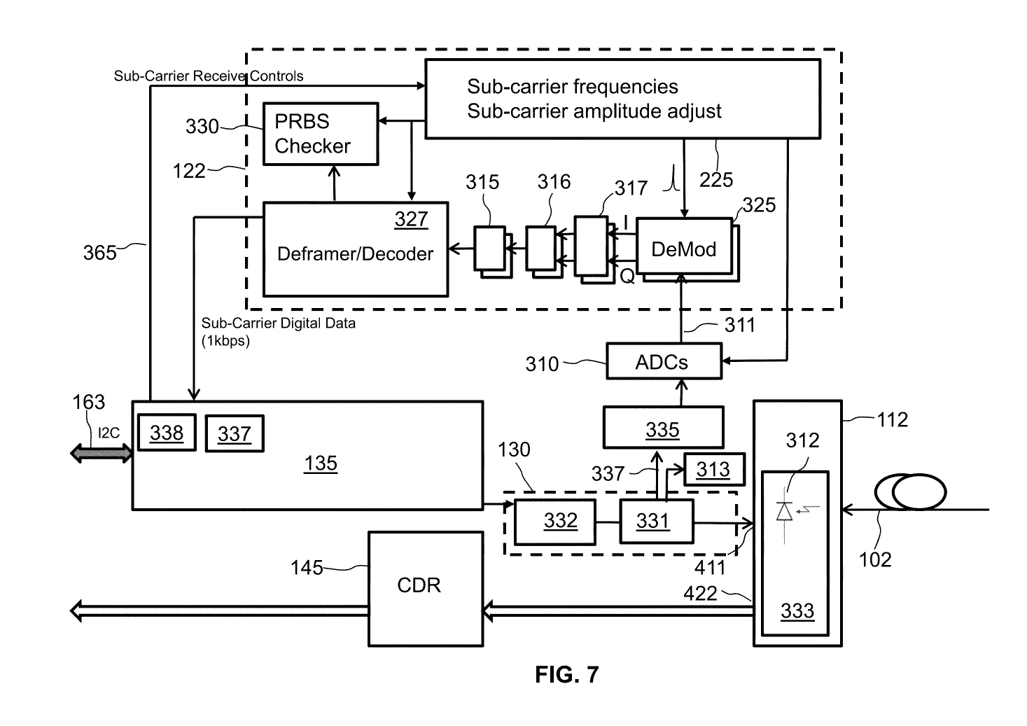

With reference to FIG. 6, in another embodiment the in-band subcarrier modulation may be achieved by using the in-band subcarrier signal 211 to modulate a fast variable optical attenuator (VOA) 255 disposed in the path of the output optical signal of the TOSA 110. In one embodiment, the fast VOA 255 may be external to the transceiver 100. In one embodiment, TOSA 110 and blocks 145, 245 may be in a separate transceiver that is located elsewhere in the network. In this embodiment, FIG. 7 illustrates a subcarrier transmitter/modulator that overlays the subcarrier modulation upon an optical signal passing through the VOA 255. For example, VOA 255 may be inserted in an optical fiber after an optical multiplexer, for example at an optical amplifier site, so that the subcarrier transmitter/modulator modulates a plurality of optical channels, thereby broadcasting the service information to a plurality of downstream transceivers.

With reference to FIG. 7, there is illustrated a schematic block diagram of a receiver sub-system of the transceiver 100 in one embodiment thereof; this block diagram may also represent a separate optical receiver device according to one aspect of the present invention. ROSA 112 includes a PD 312, such as a broad-band APD, which is optically coupled to the ‘receive’ optical fiber 102, and is electrically coupled to a PD bias and broad-band signal extraction circuit 333, an embodiment of which is illustrated in FIG. 9. In operation, an optical signal from the remote transceiver is converted by the PD 312 into an electrical PD signal, which may be for example in the form of the PD photocurrent as known in the art. At least a portion of the electrical PD signal is then provided, via a broadband port 422, to the optional CDR 145 or to the host device in the form of the broad-band received data signal, for extracting therefrom the high data rate primary signal carrying user data. Circuit 333, together with an optional CDR 154, embodies a primary signal extraction circuit, which function is to extract a broad-band electrical data signal from the electrical PD signal from the PD 312.

In accordance with the present invention, the optical receiver portion of the TR 100 is further provided with a subcarrier receiver subsystem, which includes a secondary in-band signal extraction circuit 331 for extracting from the electrical PD signal a low-frequency in-band electrical signal, and the receiver subcarrier processor 122. In one embodiment the PDCC 130 connects to a PD bias port 411, which may be in the form of a pin of an electrical connector, and includes a PD bias source 332 for generating a PD bias voltage responsive to a PD bias control signal from the main controller 135. The secondary low-frequency in-band signal extraction circuit 331 may be implemented within the PDCC 130 as an APD current sensor that is configured to extract, or ‘sense’, a low-frequency AC component 337 of the PD bias current I_{apd}, which includes an in-band subcarrier signal 337 that is carrying in-bound service data from the remote transceiver. In one embodiment, a DC component of the PD current may be coupled to a power detector 313 for a fast detection of a loss-of-signal (LOS) condition.

The in-band subcarrier signal 337 is then conditioned, such as pass-band filtered and amplified, by a subcarrier signal conditioning circuit (SSCC) 335, and then digitized by a high-speed ADC 310. The resulting digitized subcarrier signal 311 is passed to the RSP 122, which functions as a digital subcarrier receiver, for subcarrier de-modulation and extraction of the received service data. The RSP 122 includes a demodulator 325, a low-pass narrowband filter 317, a subcarrier clock and data recovery (CDR) unit 315, a data deframer/decoder unit 327, and the subcarrier frequency generator (SFG) 225, which may be shared with the MSG 121 in embodiments wherein the MSG 121 is present. In one embodiment the demodulator 325 is a BPSK demodulator, which is followed by a phase detector 316. The de-framer 327 may be coupled to an optional PRBS checker 330 for BER and transmission performance testing. The function of the PRBS checker 330 is to compare, i.e. correlate, a received test PRBS that may be comprised in the received service data with a local copy thereof provided by the PRBS checker 330, for example in order to perform BER and transmission performance testing.

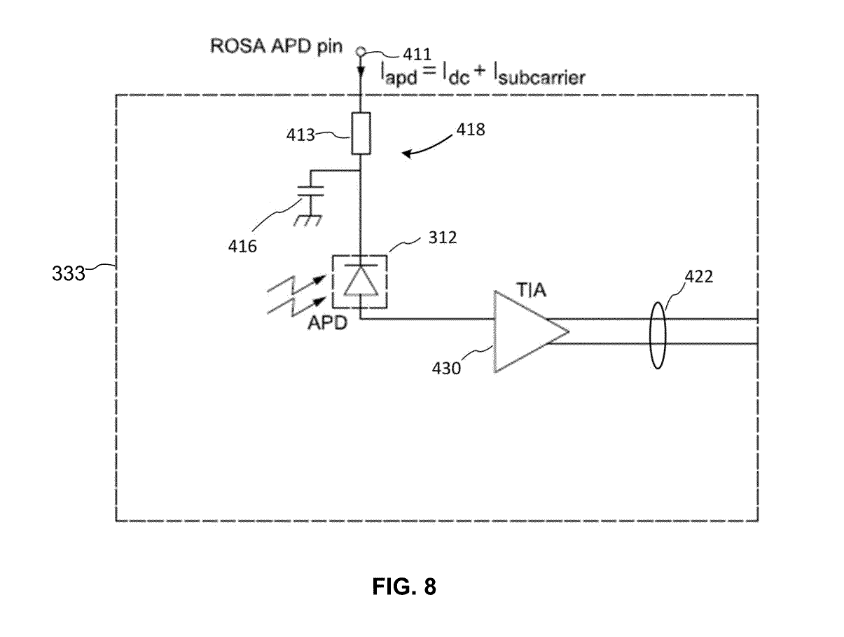

In operation, the digitized subcarrier signal 311 from ADC 310 is provided to the demodulator 325 for demodulation in accordance with the used subcarrier modulation format, such as the BPSK, and extracting therefrom a demodulated subcarrier signal. The demodulated subcarrier signal is then filtered by the narrowband filter 317. The passband of the filter 317 is preferably selected to match the subcarrier data rate to enhanced the signal to noise ratio (SNR). In one embodiment, the SFG 225 operates as a local oscillator, providing to the demodulator 325 a digital subcarrier tone at a specific subcarrier frequency fⱼ; the demodulator 325 then down-converts the received subcarrier signal 311 to the baseband. In one embodiment, the output of the demodulator 325 may be in the form of an ‘I’ and ‘Q’ baseband components as known in the art for BPSK, QPSK or other phase modulation formats. In one embodiment, the demodulator 325 may include at its output a decimating cascaded integrator-comb (CIC) filter. By way of example, the sampling rate at the input of the demodulator 325 may be in the range of 1 MHz to 40 MHz, for example 20 MHz, while the sampling rate of the baseband signal at the output of the filter 316 may be in the range of tens of kHz, for example about 30 kHz. In one embodiment, the RSP 122 may be configured to include multiple demodulators 325, each followed by its own narrowband filter 317 and its own subcarrier CDR 315, in order to extract subcarrier modulation signals from multiple subcarriers; this may be required, for example, when the optical communication device at the other side of the optical link 102 needs to send to the receiver of FIG. 8 an amount of service data that is too large for a single subcarrier, requiring the use of multiple subcarriers.

In one embodiment, the specific subcarrier frequency or frequencies to be demodulated at the receiver is selected by a receive subcarrier control logic 338 in the main controller 135, and communicated to the SFG 225 with a ‘Sub-Carrier Receive Control” signal. The SFG 225 then generates the digital tone or tones at the specified subcarrier frequency or frequencies. In one embodiment, the bandwidth of the narrowband filter 317 is optimized for the nominal subcarrier data rate Rₛ, but is less than the subcarrier spacing Δf , so that any other subcarriers with fᵢ≠fⱼ that may be present in the subcarrier signal 311 are effectively removed from the filtered modulation signal at the output of the narrowband filter 317, as well as other higher-frequency components, providing thereby a higher SNR for the desired selected received subcarrier frequency. By way of example, for the subcarrier data rate Rₛ of 1.125 kb/s and the subcarrier spacing of 10 kHz, the filter bandwidth may be selected to be in the range of 1.5-3 kHz, for example 2 kHz. The filtered subcarrier signal from the output of the tunable filter 317 is fed into the subcarrier CDR 315. The subcarrier CDR unit 315 recovers the subcarrier data signal and the subcarrier data clock, and provides these signals to the deframer 327 for decoding therefrom the in-bound service data sent by the remote transceiver.

In one embodiment, the data processing performed by the deframer 327 may include one or more of the following: frame alignment by synchronization of frame header, data de-scrambling (including 8B 10B decoding), and error corrections within limits of the used FEC algorithm, and presenting the extracted service data to the main controller 135. In one embodiment, the extracted data are passed to the main controller 135 in the form of one or more messages, each of which may correspond to a frame payload. These messages maybe processed by a corresponding target application logic 337 at the main controller 135, or may be passed by the main controller 135 for processing to the host over the data communication link 163, which may be for example in the form of an I2C bus.

With reference to FIG. 8, there is schematically illustrated an electrical circuit of ROSA 112 in one embodiment thereof. The PD 312, which by way of example is embodied as an APD, connects to an APD pin 411 of ROSA through a low-pass filter (LPF) circuit 418 that includes a capacitor 416 and a resistor 413. In operation, the electrical current flowing through the APD pin 411 is composed of a dc component I_{dc} and an ac current I_{subcarrier} due to the presence of the in-band subcarrier modulation of the received optical signal, so that I_{apd}=I_{dc}+I_{subcarrier}. The capacitor 416 and resistor 413 should be selected so that the subcarrier signal I_{subcarrier} in the desired subcarrier frequency range could be detected by the APD signal sensor 331. In a conventional ROSA, typical values of these elements are, for example, 2000 pF and 1 to 2 kOhm; however, smaller values may be preferable in embodiments of the present invention. In one exemplary embodiment, their values are selected so as not to impede the APD current in the frequency range between 100 kHz to 1500 kHz, such as in the range of 10 to 100 pF for the capacitor and 0 to 500 Ohm for the resistor 413.

The second connector of the APD 312 connects to the broad-band signal extraction circuit 430 in the form of a broad-band TIA, which converts the photocurrent generated by the APD 312 into a differential voltage signal 422 modulated with the received primary broad-band data, which is then provided to the optional CDR 145.

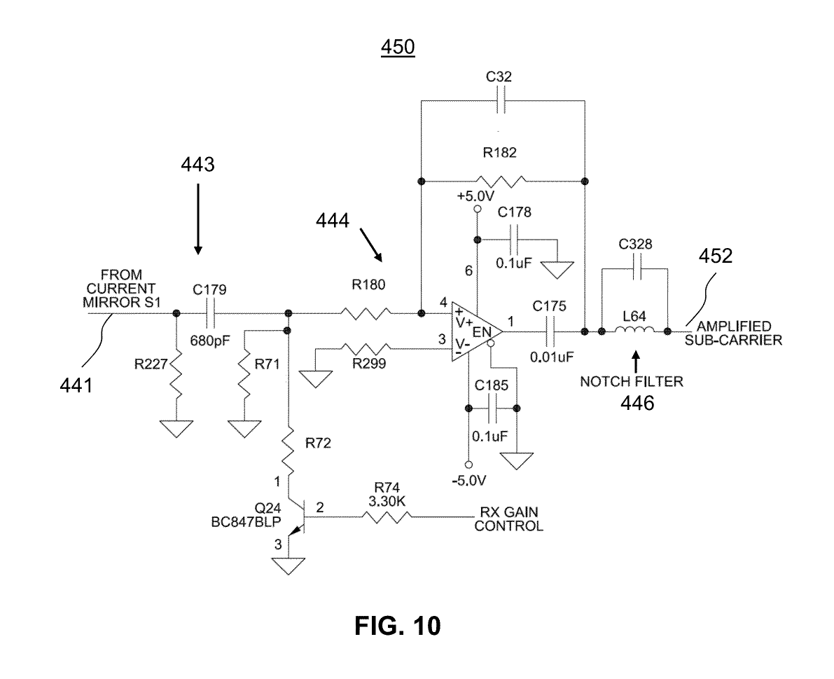

With reference to FIG. 9, there is schematically illustrated an exemplary electrical circuit of the APD current sensor 331. In the shown embodiment, the APD current sensor is implemented as a current mirror circuit having two cascaded transistor stages, with bipolar pnp transistors Q20B and Q20A, acting as a reversed and direct voltage-to-current converters. A bias port 405 provides an APD bias voltage from the APD bias controller 332 to the emitter circuits of the transistors Q20A and Q20B, thereby controlling the dc component of the APD current I_{apd}. A collector port of the first transistor Q20B is connected to the APD pin of the ROSA 112, and the APD current I_{apd} flowing therethrough is being mirrored to the collector current of the second transistor Q20A. The subcarrier-modulated AC portion of this mirrored APD current, I_{subcarrier}, is then extracted through a first output port 430 and amplified by an analog subcarrier signal amplifier, an exemplary implementation of which is illustrated in FIG. 10. In one embodiment, the dc portion of the mirrored current may be directed to the LOS detector 313 through a second output port 420.

With reference to FIG. 10 there is illustrated an exemplary embodiment of the subcarrier signal amplifier 450 for amplifying the in-band subcarrier signal I_{subcarrier} after it is extracted from the APD bias current using the circuit of FIG. 9, while blocking the dc component thereof. The mirrored APD signal from the first output port 430 of the current mirror of FIG. 10 is received at an input conductor 441, and is then passed through a high-pass filter 443 to an amplification stage 444 to suitably amplify the signal. The gain of the amplification stage 444 may be variably selected, or switched, by the main controller 135 applying a suitable RX gain control signal to a digital pin, so as to provide a suitable signal amplitude into the ADC 310 and keep it from saturation. An amplified subcarrier signal V_{sub} from the output of the amplification stage 444, now in the form of an ac voltage signal, is passed through a notch filter 446 to an output connector or port 452. The notch filter 446 is used to attenuate frequency components, for example in the range from 13 to 25 MHz, that are close to the sampling rate of the ADC 310 in order to prevent undesired aliasing effects. The subcarrier signal amplifier 450 operates substantially as an amplifying band-pass filter having a controlled gain and a substantially flat frequency response, for example within 3 dB, or preferably 2 dB, within the pass-band that is selected so as to accommodate the frequency range of the sub-carriers, for example from 100 kHz to 1500 kHz. Frequencies exceeding the highest subcarrier frequency are attenuated in order to avoid saturating the input of the ADC 310. A desired gain value of the amplifier 450 may be set by a suitable selection of resistors R182 and R180.

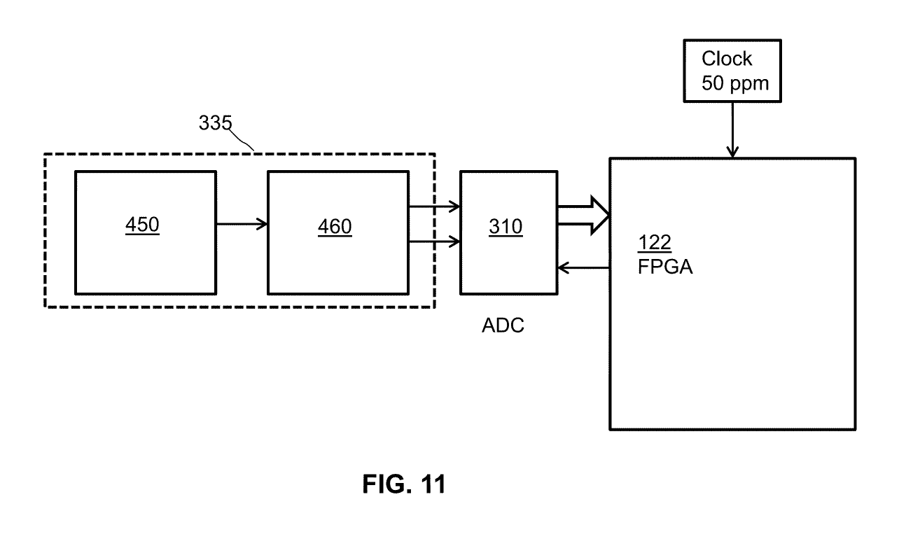

With reference to FIG. 11, in one embodiment the amplified subcarrier signal from the subcarrier amplifier 450 is further amplified by a post amplifier 460, which has a differential output that connects to the ADC 310. By way of example, the gain of this stage may be in the range of 0.5 to 4.0, depending on a particular design, to optimize the signal input to match the dynamic range of the ADC 310.

In one embodiment, some or all of the functionalities described hereinabove with reference to the RSP 122 and the MSG 121 are embodied using a single FPGA or an ASIC. Advantageously, the use of the FPGA allows the flexibility of implementing different modulation and data coding schemes as needed by a particular application. In another embodiment, the RSP 122 and MSG 121 may be implemented within an ASIC to reduce the footprint.

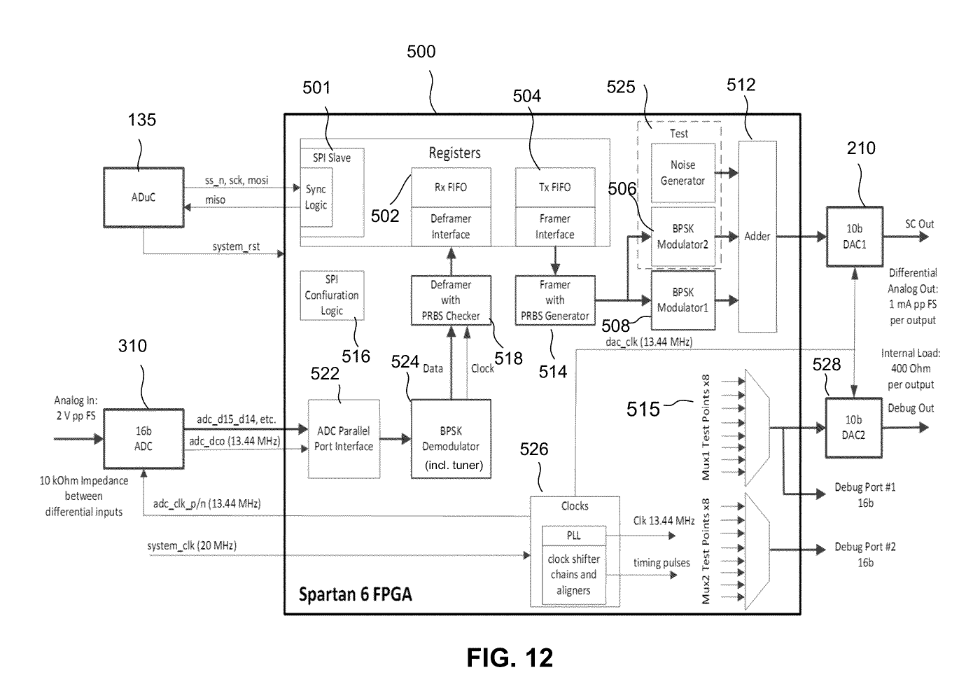

With reference to FIG. 12, there is schematically illustrated a functional block diagram of an FPGA 500 implementing the subcarrier generation and reception functionalities of the transceiver 100 in accordance with an embodiment of the present invention. The FPGA 500 includes a clock generator logic 526 for generating clock signals for various units of the FPGA 500, which are also provided to the ADC 310 and DAC 210. By way of example, the internal clock of the FPGA 500 may be at 13.44 MHz or 15.122 MHz, or as desired for a particular implementation and in dependence on the data rate of the in-band signal.

In the receive path, an ADC parallel port interface 522, which connects to the ADC 310, is followed by a BPSK modulator logic 524, which includes a tuner implementing the tunable filter 317. The BPSK modulator logic 524 is in followed by a deframer logic 518 that includes a PRBS checker logic. In operation, the digitized subcarrier signal from the ADC 310 is demodulated by the BPSK demodulator 524 in order to extract received service data, which are then processed by the deframer logic 518. An Rx FIFO 502 accumulates the processed in-bound service data, which are read by the mail controller 135 505 through an SPI bus interface 501.

In the transmit path, FPGA 505 receives the out-bound service data from the controller 135 via the SPI interface 501 and accumulates it in a Tx FIFO 504. From Tx FIFO 504, the out-bound service data are provided to a framer logic 514 which may include a PRBS generator logic. From the framer 514, the data are passed to a first BPSK modulator logic 508. In the shown embodiment, an optional second BPSK modulator logic 506 is also provided. The second BPSK modulator logic 506 in this embodiment may generate a PRBS signal for transmitting to the remote receiver on another sub-carrier. Both the second BPSK modulator 506 and a noise generator may be used for test purposes, to measure the receiver sub-carrier performance in the presence of noise and/or neighboring sub-carriers. In another embodiment, a second BPSK modulator may be used to transmit service data using a second subcarrier. Other embodiments may utilize a greater number of BPSK modulators in order to transmit service data over multiple sub-carriers, thereby flexibly increasing the sub-carrier data rate between transceivers as required. Outputs of the first and second BPSK modulators are combined by an adder 512, which incorporates subcarrier frequency generation logic and utilizes the modulator output to generate modulated subcarriers at selected subcarrier frequencies. The resulting digital subcarrier signal is output from the FPGA 500 to the DAC 210 to provide an analog subcarrier signal with two modulated sub-carriers for modulating the optical output of the transceiver. In one embodiment, the adder 512 incorporates a look-up table, which is driven by the internal clock of the FPGA, for example at 15.122 MHz, to generate the digital input into the DAC 210. Additionally, de-multiplexers 515 may be provided within the FPGA 500 for debugging purposes, enabling any internal signal to be converted to an analog representation by an optional second DAC 528 for test and measurements.

Advantageously, the aforedescribed transceiver using in-band subcarrier modulation enable communications and management to a remote transceiver or transponder module on a remote host system with no out of band OSC (Optical Supervisory Channel) access. Furthermore, associating specific sub-carrier channel frequencies with DWDM channels in embodiments of the invention provides additional means for fault diagnostics in a network, including intelligent optical channel monitoring. One such embodiment is illustrated in FIG. 1 wherein a transceiver 100-4, which is coupled to a DWDM fiber-optic link with an optical tap coupler 35 prior to the optical de-mux 25, is used as a monitor device. In this embodiment, transceiver 100-4 may lack the TOSA and/or the associated transmit path circuitry, and may be for example as illustrated in FIG. 8. In embodiments wherein each subcarrier is associated with a particular DWDM channel, tapping the power from a DWDM fiber allows such a receiver to access information related to individual DWDM channels without prior optical demultiplexing of the channels.

Furthermore, some embodiments of the invention enable transmitting and receiving more than one sub-carrier with modulated data over a single optical wavelength, to increase sub-carrier bandwidth. One skilled in the art will appreciate that this may be easily accomplished, for example, using an FPGA with a suitably large number of gates, for example by defining therein a desired number of BPSK modulators, demodulators, framers, de-framers etc. Furthermore, subcarrier-based communications between optical transceivers as described hereinabove enable such applications as remote monitoring of digital diagnostics information, identifying source ID for a WDM channel, remotely triggering line or host side loopback, and transceiver-to-transceiver communicating when the optical link therebetween is degraded so as to lose the capability to carry the primary data traffic.

Although the invention has been described with reference to specific exemplary embodiments, it is not limited thereto, and various modifications and improvements within the scope of the present invention may become apparent to a skilled practitioner based on the present description. For example, although the exemplary embodiments described hereinabove have been described with reference to WDM networks, the invention is not limited thereto and is applicable to other optical communication systems, including single optical links between two terminals or nodes, wherein there is a need to transmit not only primary information such as user data, but also secondary or service data that relates to functioning and maintenance of the system itself. Furthermore, each of the embodiments described hereinabove may utilize a portion of another embodiment. Of course numerous other embodiments may be envisioned without departing from the spirit and scope of the invention.

We claim:

1. An optical receiver for an optical communication system, comprising:
a photodetector (PD) for converting an incoming optical signal into an electrical PD signal;
a primary signal extraction circuit coupled to the PD for extracting a broad-band electrical data signal from the electrical PD signal; and,
a subcarrier receiver subsystem, comprising:
a secondary in-band signal extraction circuit coupled to the PD for extracting from the electrical PD signal a low-frequency in-band electrical signal; and,
a received subcarrier processor coupled to the in-band signal extraction circuit for extracting one or more modulated subcarriers from the low-frequency in-band electrical signal, and for extracting received service data therefrom.

2. The optical receiver of claim 1, wherein the received subcarrier processor comprises
a subcarrier demodulator for selecting and demodulating the one or more modulated subcarriers from the low-frequency in-band electrical signal to obtain a de-modulated subcarrier signal carrying the received service data.

3. The optical receiver of claim 2, wherein the received subcarrier processor further comprises a subcarrier generator coupled to the subcarrier demodulator, and wherein the subcarrier demodulator comprises a tunable narrow-band subcarrier filter for tunably selecting the one or more modulated subcarriers.

4. The optical receiver of claim 1, wherein the received subcarrier processor further comprises a data decoder and deframer for identifying data frames in the de-modulated subcarrier signal and decoding payload thereof.

5. The optical receiver of claim 1, wherein the secondary in-band signal extraction circuit comprises a PD current sensing circuit electrically followed by an ac-coupled signal conditioning circuit.

6. The optical receiver of claim 1, further comprising a memory for storing subcarrier association data associating a plurality of subcarrier frequencies to a plurality of WDM optical channels.

7. An optical transmitter for an optical communication system, comprising:
a light emitting module;
a broad-band electrical driver electrically coupled to the light emitting module for modulating an output light thereof with a broad-band electrical data signal carrying high-speed data;
a subcarrier modulation subsystem for modulating the output light with a low-frequency in-band modulated subcarrier signal carrying out-bound service data, the subcarrier modulation subsystem comprising
a modulated subcarrier generator (MSG) for generating one or more in-band subcarriers modulated with the out-bound service data;
wherein subcarrier frequencies of the one or more in-band subcarriers are selected from a plurality of designated subcarrier frequencies that lie within a modulation frequency band of the primary broad-band electrical modulation signal.

8. The optical transmitter of claim 7, wherein the modulated subcarrier generator comprises a data encoder operatively followed by a narrow-band sub-carrier modulator and a direct digital synthesizer.

9. The optical transmitter of claim 7, wherein the subcarrier modulation subsystem comprises a digital to analog converter (DAC) for converting the one or more in-band subcarriers into the low-frequency in-band subcarrier signal for modulating the output light of the light emitting diode therewith.

10. The optical transmitter of claim 8, wherein the modulated subcarrier generator further comprises a subcarrier frequency generator coupled to the direct digital synthesizer.

11. The optical transmitter of claim 8, wherein the narrow-band sub-carrier modulator is configured for generating a shaped BPSK signal having phase transitions shaped for reducing a modulation bandwidth of the one or more subcarriers.

12. The optical transmitter of claim 7, wherein the plurality of designated subcarrier frequencies comprise subcarrier frequencies in a frequency band from 100 to 1500 kHz and are spaced 5 to 20 kHz apart for carrying service data at a subcarrier data rate in a data rate range from 100 bits per second (bps) to 5000 bps.

13. The optical transceiver comprising an optical transmitter of claim 7 and an optical receiver of claim 1, wherein the received subcarrier processor and the modulated subcarrier generator are implemented using an FPGA.

14. A method of communication in an optical communication system, comprising:
utilizing a broad-band modulation of optical signals in a primary frequency band for transmitting primary data; and,
utilizing a plurality of low-frequency in-band subcarriers to modulate the optical signals to transmit secondary data between nodes of the optical communication system;
wherein the plurality of low-frequency subcarriers lie at least in part within the primary frequency band.

15. The method of claim 14, wherein the primary data comprises user generated data, and the secondary data comprises service data of the optical communication system.

16. The method of claim 14, wherein the optical signals are transmitted over multiple wavelength-multiplexed channels, and wherein each of the multiple wavelength-multiplexed channels is associated with one or more subcarriers.

17. The method of claim 14, wherein two or more subcarriers are used to modulate an optical signal within a single wavelength-multiplexed channel.

18. The method of claim 14, wherein each subcarrier is modulated using a BPSK modulation format to carry service data.

19. The method of claim 18, wherein the BPSK modulation format comprises shaped BPSK wherein phase transitions are smoothed over a fraction of one symbol interval in order to reduce a spectral width of the modulated subcarrier.

20. The method of claim 14, wherein the service data is packetized into frames prior to being modulated onto one of the subcarriers.
